(19) United States
(12) Patent Application Publication
(10) Pub. No.: US 2020/0290299 A1
(43) Pub. Date: Sep. 17, 2020

(54) Tire with Tread Pattern and Casing Cooperation

(71) Applicant: Mark H. Mineur, Fernandina Beach, FL (US)

(72) Inventor: Mark H. Mineur, Fernandina Beach, FL (US)

(21) Appl. No.: 16/820,605

(22) Filed: Mar. 16, 2020

Related U.S. Application Data
(60) Provisional application No. 62/819,480, filed on Mar. 15, 2019.

(51) Int. Cl. B29D 30/54; B60C 11/11; B60C 11/13; B60C 9/20

(52) U.S. Cl. CPC B29D 30/54; B60C 11/11; B60C 11/13; B60C 2009/2019; B29D 2030/548; B60C 2009/2016; B60C 9/20

(57) ABSTRACT

A tire may be re-treaded utilizing a process in which a worn tread is removed from a casing. The worn tread had a first tread pattern. The casing has a tire body encapsulating at least one reinforcing belt, the at least one reinforcing belt embedded circumferentially in the tire body, the at least one reinforcing belt having lateral edges. The first tread pattern comprises a first plurality of universal bands of raised portions, where the first plurality of universal bands were situated over the lateral edges of the at least one belt. A new tread having a second tread pattern different from the first tread pattern is molded to the first casing. The second tread pattern comprises a second plurality of universal bands of raised portions that are situated in the same lateral locations as the first plurality of universal bands.

### PRIOR APPLICATION

This application claims the benefit of U.S. Provisional Application No. 62/819,480 filed Mar. 15, 2019, the disclosure of which is incorporated by reference herein in its entirety.

### TECHNICAL FIELD

Embodiments described herein generally relate to tires and, more particularly, to truck tires having construction and tread patterns suitable for high-speed, long-distance hauling.

### BACKGROUND

Tires, and truck tires in particular, are manufactured for safety and durability. Modern tire fabrication produces extremely durable tire casing that can far outlast the tread under typical use conditions. Over the last 20 years, re-treading of worn truck tires has become advantageous for a number of reasons, including cost savings, energy savings, and reduction of waste material. Typically, 80% of the worn tire can be reused with a fresh tread pattern applied.

There remain a number of challenges with re-treading tires, including producing tires that can provide the same or similar performance, safety, and durability as newly-fabricated ones. Solutions are needed that address these, and other unresolved concerns.

### BRIEF DESCRIPTION OF THE DRAWINGS

FIG. 1 is a perspective-view diagram illustrating a portion of a drive tire having casing and a tread formed over the casing according to some embodiments.

FIG. 2 is a perspective-view diagram of a non-drive tire having the same casing as described with reference to FIG. 1, and a tread formed over that casing, according to related embodiments.

FIG. 3 is a perspective-view diagram illustrating a section of drive-tire tread in greater detail according to some examples.

FIG. 4 is a perspective-view diagram illustrating a section of non-drive tread in greater detail according to some examples.

FIG. 5 is a partial cross-sectional-view schematic diagram facing along the circumferential direction in which a portion of an assembled tire includes a casing and a tread that is either tread a drive or non-drive tread, according to some examples.

FIG. 6 illustrates examples of universal bands of raised portions of treads according to some examples.

FIGS. 7 and 8 are schematic diagrams illustrating the construction of reinforcing belts according to some examples.

FIG. 9 is a schematic diagram illustrating cooperation between the reinforcing belts and certain tread patterns according to some embodiments.

FIG. 10 is a process for re-treading a tire in accordance with aspects of the embodiments.

### DETAILED DESCRIPTION

The following description and the drawings sufficiently illustrate specific embodiments to enable those skilled in the art to practice them.

One aspect of the embodiments are directed to a truck tire having a tread pattern optimized for the drive wheel position of a tractor truck.

Another aspect is directed to a truck tire having a tread pattern optimized for a non-driven wheel position of a tractor truck.

Other aspects are directed to various structural features that facilitate compatibility between the tread pattern and the casing construction of the tire. In one such embodiment, the grooves, sipes, or other indentations of the tread are positioned at a minimum lateral distance away from the edges of the steel reinforcing belts that are integrated into the casing. Equivalently, the raised or thicker portions of the tread, such as the plateaus, ridges, or shoulders, are positioned over the belt edges. Advantageously, in this type of embodiment, the grooves, sipes or other indentations of the tread pattern function as hinges when the tire rolls over real-world road surfaces which are naturally uneven. Likewise, the belt edges act as hinges. This arrangement, as described in greater detail below, spatially separates the hinges and distributes the lateral flexing of the equatorial plane of the tire to improve evenness-of-wear characteristics and the durability of the casing treat and the tire casing. Likewise, distribution of hinges in the tire is advantageous from a heat-management standpoint since hinges tend to generate heat in the tire. Thus, distribution of the hinges tends to make the heating more uniform throughout the body of the tire, thereby improving the service life of the tire.

In a related aspect, the predominant grooves or sipes of the tread pattern are angled off-axis with respect to direction of travel (i.e., the circumferential centerline) of the tire so that they are in general alignment with the spiral angles of the cords of one or more of the belts in the casing of the tire. This enhances lateral flexing to improve the ride quality and handling performance of the tire.

In another related aspect, a process for re-treading a tire is described in which the casing of a tire with a worn tread may be reused with a new tread pattern formed thereupon. Notably, the new tread pattern may be different from the original tread pattern, provided that the new tread pattern is compatible with the tire casing based on one or both of the aspects described above. For instance, a tire may be re-treaded with a new and different tread pattern in which (a) the plateaus, ridges, or shoulders are positioned over the lateral edges of the belts in the casing; (b) the spiral angles of the steel cords of one or more reinforcing belts are similar to the angles of the predominant grooves or sipes of the tread pattern; or both conditions (a) and (b) are met.

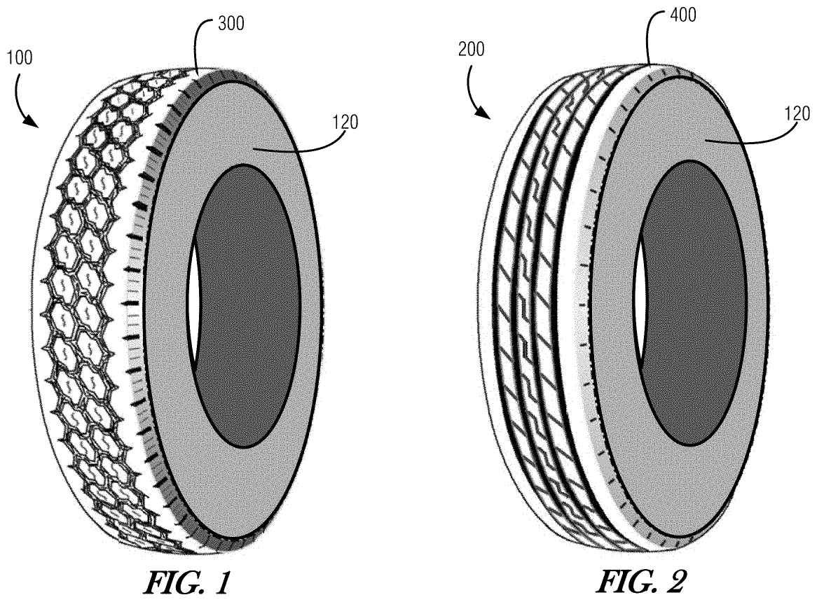

FIG. 1 is a perspective-view diagram illustrating a portion of a drive tire 100 having casing 120 and a tread 300 formed over the casing 120. Casing 120 includes conventional features that are not specifically shown, such as a body ply comprising one or more layers of fabric cords, a pair of beads, each including a hoop of high-tensile steel wires wrapped in a loop of the body ply, sidewall reinforcement, and a set of reinforcing belts made from steel cords, all encapsulated in a rubber tire body. As will be described in greater detail below, tread 300 has a pattern that is optimized for a drive-position wheel according to an example embodiment.

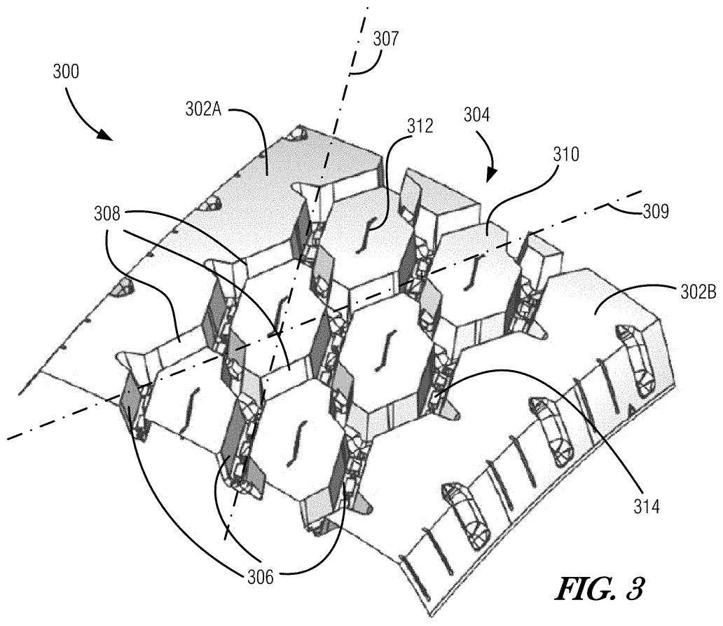

FIG. 2 is a perspective-view diagram of a non-drive tire 200 having casing 120 and a tread 400 formed over the casing 120. Notably, the same casing 120 is used for the non-drive tire 200 as for drive tire 100. As will be described in greater detail below, tread 300 has a pattern that is optimized for a non-drive-position wheel according to an example embodiment.

In related embodiments, as will be described below, treads 300 and 400 are interchangeable in a re-treading operation, which may be performed when a given tread is worn and casing 120 has useful life remaining.

FIG. 3 is a perspective-view diagram illustrating a section of tread 300 in greater detail. Tread pattern 300 is a closed-shoulder design that includes shoulder 302A and shoulder 302B. Between shoulders 302A, 302B is a tread pattern that includes grooves 304 and plateau portions 310. As illustrated, the predominant portions of grooves 304 are oriented along two off-center axes: groove portions 306 are oriented along off-center axis 307, and groove portions 308 are oriented along off-center axis 309.

Plateau portions 310 are polygonal raised portions having a set of concave and convex sides as depicted. Each plateau portion 310 has a major dimension along the circumference of the tire, and a minor dimension laterally across the surface of the tire. Each plateau portion 310 has relatively longer sides and relatively shorter sides. Each of the relatively longer sides are aligned with either off-center axis 307, or off-center axis 309, which defines the predominant portions of grooves 304. Each plateau portion 310 includes an integral-shaped sipe 312 as shown, with a major portion oriented along off-center axis 307.

At the floor of grooves 304 are stone-ejector features 314. The stone-ejector features 314 are rectangular upward protrusions having alternating widths.

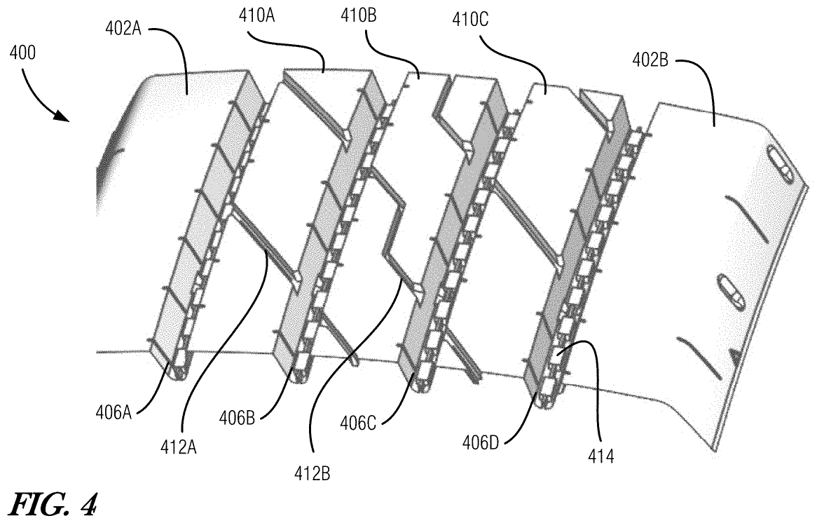

FIG. 4 is a perspective-view diagram illustrating a section of tread 400 in greater detail. Tread pattern 400 is a closed-shoulder design that includes shoulder 402A and shoulder 402B. Between shoulders 402A and 402B is a tread pattern that includes circumferential grooves 406A, 406B, 406C, and 406D, which are all parallel and oriented along the circumferential centerline of the tire. Between each adjacent pair of the circumferential grooves 406 is a corresponding ridge 410A, 410B, or 410C. Each ridge is a raised portion that runs the length of the tire's circumference. Ridges 410A and 410C have angled sipes 412A as shown, whereas ridge 410B has compound sipes 412B, which include circumferential segments and angled segments as shown, with the angled segments in general alignment with corresponding angled sipes 412A formed in rides 410A and 410C.

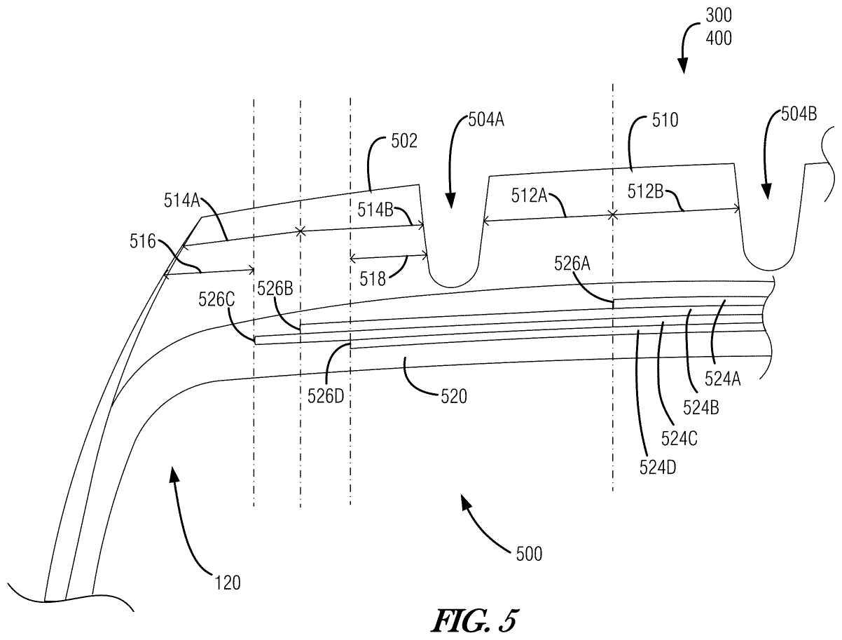

FIG. 5 is a partial cross-sectional-view schematic diagram facing along the circumferential direction. As illustrated, a portion of an assembled tire 500 includes tire casing 120, and a tread that is either tread 300 or tread 400. As depicted, tire 500 includes tire body 520, which encapsulates reinforcing belts 524A, 524B, 524C, and 524D. As will be described in greater detail below, each reinforcing belt 524 is formed from a set of rubberized steel cords that are arranged in parallel at a “spiral angle” relative to the circumferential centerline of the tire. Notably, the various belts 524 have different widths, as shown respectively at ends 526A, 526B, 526C, and 526D.

Tread 300, 400 in this example includes shoulder 502, such as shoulder 302, 402 as described above, and raised portion 510, which may represent either ridge 310 or plateau 410. The shoulder 502, and ridge or plateau 510 are each a raised portion of the tread 300, 400. Between the raised portions are grooves 504A, 504B. Notably, each belt end 526 is positioned relative to the pattern of tread 300, 400 such that each belt end 526 is situated below a corresponding raised portion 502, 504. For example, as shown, belt end 526A is situated beneath raised portion 510, at a lateral distance 512A from the left-most groove 504A as shown, and at a lateral distance 512B from the next groove 504B to the right. In an example embodiment, lateral distances 512A and 512B are similar. Hence, the hinge effected by belt edge 602A is distributed between the hinges effected by grooves 504 on either side. In various related embodiments, the belt end 526A may be off-center between the adjacent grooves 504, such that lateral distances 512A and 512B are different by a factor of 0.3 or less. In a related embodiment, lateral distances 512A and 512B are different by a factor of 0.15 or less. In a related embodiment, lateral distances 512A and 512B are different by a factor of 0.10 or less.

Similarly, belt ends 526B, 526C, and 526D are all situated beneath raised portion 502. Belts 524B, 524C, and 524D are all different widths to spatially distribute the hinge effect produced by each corresponding belt end 526B, 526C, 526D. However, each belt end 526 is positioned under a substantial bulk of material constituting shoulder 502 as shown. Belt end 526B is positioned at a lateral distance 514A from the edge of the tire and lateral distance 514B from left-most groove 504A. Lateral distances 514A and 514B may be similar in some embodiments, or may vary from one another by some limited extent, such as by a factor of 0.3 or less, 0.15 or less, or 0.10 or less.

Belt end 526C is situated at a lateral distance 516 from the edge of the tire. In some embodiments, lateral distance 516 is at least half the length of lateral distance 514A. Belt end 526D is situated at a lateral distance 518 from groove 504B as shown. In some embodiments, lateral distance 518 is at least half the length of lateral distance 514B. Hence, in some embodiments, all three belt ends beneath a common raised portion 502 are situated laterally in the middle 50% of that raised portion 502. In a related embodiment, the multiple belt ends beneath a common raised portion 502 are laterally distributed within the middle 50% of the lateral width of that raised portion 502.

In a related embodiment, raised portions 502 and 510 as shown in FIG. 5 represent universal bands of raised portions of the tread that extend around the tire's circumference. The universal bands universal with respect to different tread patterns from treads 300 or 400, or from other treads that are compatible with casing 120. Each universal band of raised portions 502, 510 may be a band defined as a lateral portion of a shoulder 302, 402 or a lateral portion of plateau 310 or ridge 410.

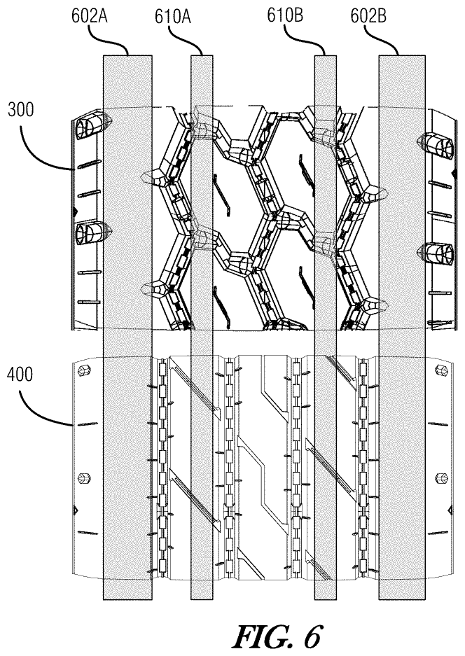

FIG. 6 illustrates examples of universal bands of raised portions of treads. As shown, universal bands 602A, 602B, 610A, 610B, as embodied in treads 300 and 400 are highlighted. Universal bands 602A and 602B are embodied as portions of the shoulders of treads 300 and 400. Universal bands 610A, 610B are embodied as portions of the plateaus on each side of tread 300 while at the same time being embodied as portions of ridges on either side of tread 400. Each of universal bands 602A, 602B, 610A, 610B are a respective portion of tread 300, 400 that tend to provide a relatively low hinge effect for lateral flexing of the tread.

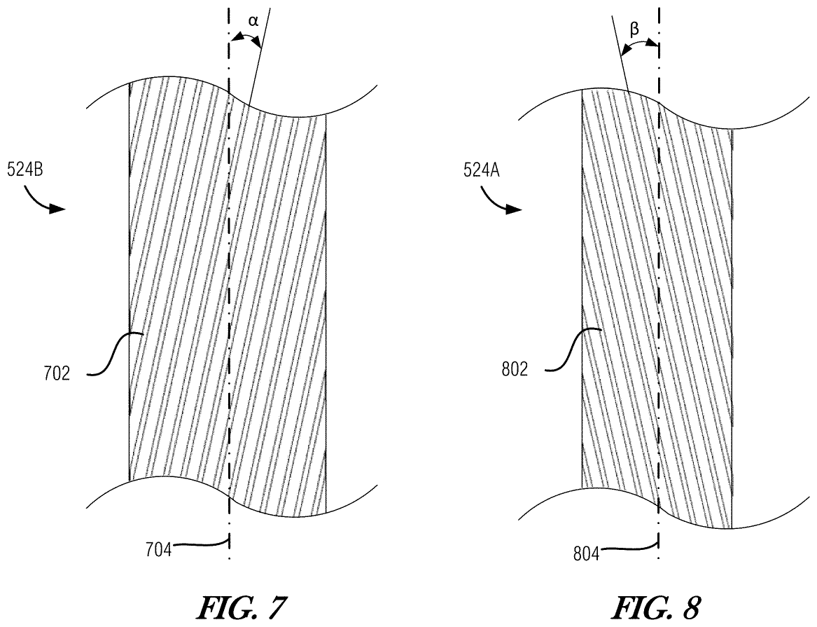

FIGS. 7 and 8 are schematic diagrams illustrating the construction of reinforcing belts 524B and 524A, respectively. Reinforcing belt 524B shown in FIG. 7 is composed of steel cord 702 aligned in parallel at an off-center angle α relative to circumferential centerline axis 704. In some embodiments, angle α is 22 degrees to the right of circumferential centerline axis 704. Reinforcing belt 524B is most flexible about an axis aligned at angle α. Steel belt 524A shown in FIG. 8 is composed of steel cord 802 aligned in parallel at an off-center angle β relative to circumferential centerline axis 804. In some embodiments, angle β is 22 degrees to the left of circumferential centerline axis 804. Reinforcing belt 524A is most flexible about an axis aligned at angle β. For each belt 524, the steel cord may be encapsulated in rubber or other suitable material that is compatible with tire body 520.

The other belts may have similar construction to that of belts 524B, 524A. For instance, belt 524C may have cord oriented at angle β. Belt 524D may have cord oriented at a different angle, such as 55 degrees to the right.

According to one example of a belt system, belt 524D, the third widest belt, is at an angle of 55 degrees to the right. It is arranged as a transition belt having a spiral angle between the radial orientation of the cords in the tire's carcass of 90 degrees, and the other belts. Belt 524C is the widest belt and is at an angle of 22 degrees to the left. This belt is arranged as a working belt. Belt 524B is the second-widest belt and is at an angle of 22 degrees to the right. This belt is also arranged as a working belt. 524A is the narrowest belt and is at an angle of 22 degrees to the left. This belt comprises of a different type of steel wire and is arranged as a high-elongation belt.

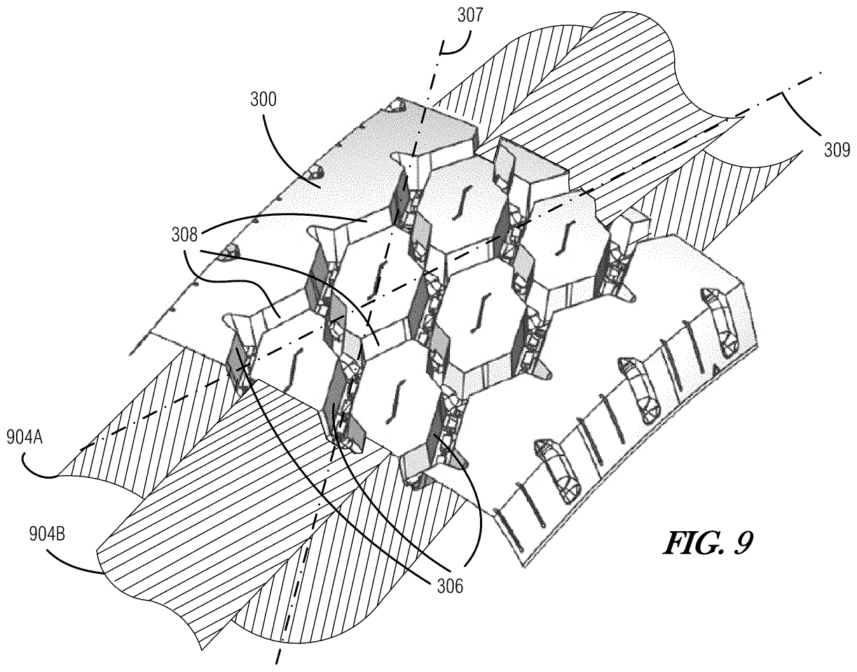

FIG. 9 is a schematic diagram illustrating cooperation between the reinforcing belts and certain tread patterns according to some embodiments. As depicted, tread pattern 300 includes first off-center axis 307, and a second off-center axis 309, with groove portions 306 being examples of predominant portions of grooves along axis 307, and groove portions 308 being examples of predominant portions of grooves along axis 309.

According to this embodiment, reinforcing belt 904A is composed of steel cords oriented along off-center axis 307, whereas reinforcing belt 904B is composed of steel cords oriented along off-center axis 309. Accordingly, the combination of spiral angles of the reinforcing belts 904, and the predominant portions of the grooves, cooperate to facilitate flexibility of the tread along desired axes of flexure. In a related embodiment, the orientation of the spiral angles of the cords in belts 904 and the respective off-center axes are not matched precisely, but are within +/−10 degrees. In a related embodiment, the spiral angles of the cords in belts 904 and the respective off-center axes are within +/−5 degrees.

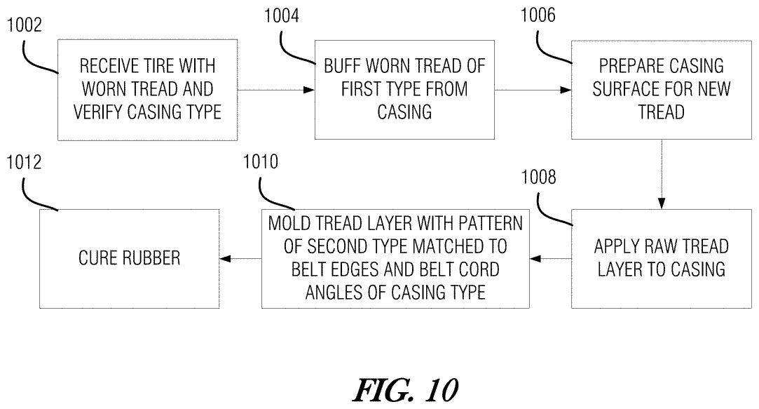

FIG. 10 is a process for re-treading a tire in accordance with aspects of the embodiments in which the new tread may be different from the previous (worn) tread but meets compatibility criteria such that there is functional, as well as structural, cooperation between the tread and the tire's casing. Accordingly, at 1002, a tire with worn tread to be replaced is received, and the casing type is verified. In these operations, the casing type is indicative of the construction of the casing, namely, the arrangement of belts, their respective widths and lateral positions of the ends of the belts. In addition, the casing type may be indicative of the spiral angles of the steel cords from which the belts are composed. If the casing type does not match a predefined list of accommodated types, the tire may be rejected. Otherwise, if the casing type is supported, the process advances to the physical operations.

At 1004, the worn tread is removed from the casing. The removal process may be a buffing operation as known in the art. In this example, the worn tread may be of a first type (e.g., non-drive tread). At 1006, the surface of the tire casing is prepared to receive the replacement tread. Surface preparation may involve inspection and any repair, as needed, of irregularities, as well as application of an adhesive, a catalyst, or other suitable surface treatment. At 1008, a raw tread layer is applied along the circumference of the casing. In this example, the raw tread layer may lack any tread pattern at this point.

At 1010, the raw tread layer is molded with a tread pattern that is compatible with the casing. The tread layer may be molded with a second type of tread pattern different from the one that was previously removed, but nonetheless cooperative with the casing. Accordingly, the new tread pattern may include raised portions consistent with universal bands which are suitably aligned with the belt edges of the casing. Likewise, the new tread pattern may include one or more predominant groove angles that are in alignment with the spiral angles of the steel cord of one or more reinforcing belts.

At 1012, the new tread is cured and fused with the casing.

### ADDITIONAL NOTES AND EXAMPLES

Example 1 is a set of tires, comprising: a first tire including: a first casing of a first type having a tire body encapsulating at least one reinforcing belt, the at least one reinforcing belt embedded circumferentially in the tire body, the at least one reinforcing belt having lateral edges; and a first tread portion formed circumferentially over the first casing, the first tread portion including recessed grooves and raised portions arranged as a first tread pattern that comprises a first plurality of universal bands of raised portions, wherein the first plurality of universal bands are situated over the lateral edges of the at least one belt; and a second tire including: a second casing of the first type; and a second tread portion formed circumferentially over the second casing, the second tread portion including recessed grooves and raised portions arranged as a second tread pattern that is different from the first tread pattern and that comprises a second plurality of universal bands of raised portions, wherein the second plurality of universal bands are situated in the same lateral locations as the first plurality of bands.

In Example 2, the subject matter of Example 1 includes, wherein in the at least one reinforcing belt includes a plurality of parallel metal cords that are oriented at a first offset angle relative to a circumferential centerline of the tire body.

In Example 3, the subject matter of Example 2 includes, wherein the recessed grooves of the second tread pattern include portions oriented at the first offset angle.

In Example 4, the subject matter of Examples 2-3 includes, wherein the recessed grooves of the second tread pattern include portions oriented within 10 degrees of the first offset angle.

In Example 5, the subject matter of Examples 1-4 includes, wherein the first plurality of universal bands include a first set of universal bands defined by a closed-shoulder of the first and the second tread patterns, and a second set of universal bands defined by a series of plateaus having a major dimension along the circumferential direction and a minor dimension along the lateral direction relative to the tire.

In Example 6, the subject matter of Example 5 includes, wherein the second plurality of universal bands include a first set of universal bands defined by a closed-shoulder of the first and the second tread patterns, and a second set of universal bands defined by a circumferential ridge.

In Example 7, the subject matter of Examples 1-6 includes, wherein the plurality of reinforcing belts includes: a first reinforcing belt having a first lateral edge beneath a first one of the universal bands and second lateral edge beneath a second one of the universal bands; and a second reinforcing belt having a third lateral edge beneath a third one of the universal bands and fourth lateral edge beneath a fourth one of the universal bands.

In Example 8, the subject matter of Example 7 includes, wherein the plurality of reinforcing belts includes: a third reinforcing belt having a fifth lateral edge beneath the first one of the universal bands and sixth lateral edge beneath the second one of the universal bands.

In Example 9, the subject matter of Examples 7-8 includes, wherein the first, second, third, and fourth lateral edges are each situated beneath a middle 50% of the width of each corresponding one of the universal bands.

Example 10 is a tire, comprising: a casing of a first type having a tire body encapsulating at least one reinforcing belt, the at least one reinforcing belt embedded circumferentially in the tire body, the at least one reinforcing belt having a plurality of parallel metal cords that are oriented at a first offset angle relative to a circumferential centerline of the tire body; and a tread portion formed circumferentially over the casing, the tread portion including recessed grooves and raised portions arranged as a first tread pattern wherein the recessed grooves of the first tread pattern include, predominant portions oriented in approximate alignment with the first offset angle.

In Example 11, the subject matter of Example 10 includes, wherein the approximate alignment is within 10 degrees of the first offset angle.

In Example 12, the subject matter of Examples 10-11 includes, wherein the approximate alignment is within 5 degrees of the first offset angle.

In Example 13, the subject matter of Examples 10-12 includes, wherein the raised portions of the tread portion include a series of plateaus having a major dimension along the circumferential direction and a minor dimension along the lateral direction relative to the tire, and wherein each of the plateaus has a polygonal shape including relatively longer sides and relatively shorter sides, and wherein the relatively longer sides are aligned with the first offset angle.

Example 14 is a method for re-treading a tire, the method comprising: removing a worn tread having a first tread pattern from a first casing, the first casing having a tire body encapsulating at least one reinforcing belt, the at least one reinforcing belt embedded circumferentially in the tire body, the at least one reinforcing belt having lateral edges, and wherein the first tread pattern comprises a first plurality of universal bands of raised portions, wherein the first plurality of universal bands were situated over the lateral edges of the at least one belt; molding a new tread having a second tread pattern different from the first tread pattern to the first casing, the second tread pattern comprising a second plurality of universal bands of raised portions, wherein the second plurality of universal bands are situated in the same lateral locations as the first plurality of bands.

In Example 15, the subject matter of Example 14 includes, wherein in the at least one reinforcing belt includes a plurality of parallel metal cords that are oriented at a first offset angle relative to a circumferential centerline of the tire body.

In Example 16, the subject matter of Example 15 includes, wherein the recessed grooves of the second tread pattern include portions oriented approximately at the first offset angle.

In Example 17, the subject matter of Examples 14-16 includes, wherein the first plurality of universal bands include a first set of universal bands defined by a closed-shoulder of the first and the second tread patterns, and a second set of universal bands defined by a series of plateaus having a major dimension along the circumferential direction and a minor dimension along the lateral direction relative to the tire.

In Example 18, the subject matter of Example 17 includes, wherein the second plurality of universal bands include a first set of universal bands defined by a closed-shoulder of the first and the second tread patterns, and a second set of universal bands defined by a circumferential ridge.

In Example 19, the subject matter of Examples 14-18 includes, wherein the plurality of reinforcing belts includes: a first reinforcing belt having a first lateral edge beneath a first one of the universal bands and second lateral edge beneath a second one of the universal bands; and a second reinforcing belt having a third lateral edge beneath a third one of the universal bands and fourth lateral edge beneath a fourth one of the universal bands.

In Example 20, the subject matter of Example 19 includes, wherein the plurality of reinforcing belts includes: a third reinforcing belt having a fifth lateral edge beneath the first one of the universal bands and sixth lateral edge beneath the second one of the universal bands.

In Example 21, the subject matter of Examples 19-20 includes, wherein the first, second, third, and fourth lateral edges are each situated beneath a middle 50% of the width of each corresponding one of the universal bands.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A set of tires, comprising:
a first tire including:
a first casing of a first type having a tire body encapsulating at least one reinforcing belt, the at least one reinforcing belt embedded circumferentially in the tire body, the at least one reinforcing belt having lateral edges; and
a first tread portion formed circumferentially over the first casing, the first tread portion including recessed grooves and raised portions arranged as a first tread pattern that comprises a first plurality of universal bands of raised portions, wherein the first plurality of universal bands are situated over the lateral edges of the at least one belt; and
a second tire including:
a second casing of the first type; and
a second tread portion formed circumferentially over the second casing, the second tread portion including recessed grooves and raised portions arranged as a second tread pattern that is different from the first tread pattern and that comprises a second plurality of universal bands of raised portions, wherein the second plurality of universal bands are situated in the same lateral locations as the first plurality of universal bands.

2. The set of claim 1, wherein in the at least one reinforcing belt includes a plurality of parallel metal cords that are oriented at a first offset angle relative to a circumferential centerline of the tire body.

3. The set of claim 2, wherein the recessed grooves of the second tread pattern include portions oriented at the first offset angle.

4. The set of claim 2, wherein the recessed grooves of the second tread pattern include portions oriented within 10 degrees of the first offset angle.

5. The set of claim 1, wherein the first plurality of universal bands include a first set of universal bands defined by a closed-shoulder of the first and the second tread patterns, and a second set of universal bands defined by a series of plateaus having a major dimension along the circumferential direction and a minor dimension along the lateral direction relative to the tire.

6. The set of claim 5, wherein the second plurality of universal bands include a first set of universal bands defined by a closed-shoulder of the first and the second tread patterns, and a second set of universal bands defined by a circumferential ridge.

7. The set of claim 1, wherein the plurality of reinforcing belts includes:
a first reinforcing belt having a first lateral edge beneath a first one of the universal bands and second lateral edge beneath a second one of the universal bands; and
a second reinforcing belt having a third lateral edge beneath a third one of the universal bands and fourth lateral edge beneath a fourth one of the universal bands.

8. The set of claim 7, wherein the plurality of reinforcing belts includes:
a third reinforcing belt having a fifth lateral edge beneath the first one of the universal bands and sixth lateral edge beneath the second one of the universal bands.

9. The set of claim 7, wherein the first, second, third, and fourth lateral edges are each situated beneath a middle 50% of the width of each corresponding one of the universal bands.

10. A tire, comprising:
a casing of a first type having a tire body encapsulating at least one reinforcing belt, the at least one reinforcing belt embedded circumferentially in the tire body, the at least one reinforcing belt having a plurality of parallel metal cords that are oriented at a first offset angle relative to a circumferential centerline of the tire body; and
a tread portion formed circumferentially over the casing, the tread portion including recessed grooves and raised portions arranged as a first tread pattern wherein the recessed grooves of the first tread pattern include predominant portions oriented in approximate alignment with the first offset angle.

11. The tire of claim 10, wherein the approximate alignment is within 10 degrees of the first offset angle.

12. The tire of claim 10, wherein the raised portions of the tread portion include a series of plateaus having a major dimension along the circumferential direction and a minor dimension along the lateral direction relative to the tire, and wherein each of the plateaus has a polygonal shape including relatively longer sides and relatively shorter sides, and wherein the relatively longer sides are aligned with the first offset angle.

13. A method for re-treading a tire, the method comprising:
removing a worn tread having a first tread pattern from a first casing, the first casing having a tire body encapsulating at least one reinforcing belt, the at least one reinforcing belt embedded circumferentially in the tire body, the at least one reinforcing belt having lateral edges, and wherein the first tread pattern comprises a first plurality of universal bands of raised portions, wherein the first plurality of universal bands were situated over the lateral edges of the at least one belt;
molding a new tread having a second tread pattern different from the first tread pattern to the first casing, the second tread pattern comprising a second plurality of universal bands of raised portions, wherein the second plurality of universal bands are situated in the same lateral locations as the first plurality of universal bands.

14. The method of claim 13, wherein in the at least one reinforcing belt includes a plurality of parallel metal cords that are oriented at a first offset angle relative to a circumferential centerline of the tire body.

15. The method of claim 14, wherein the recessed grooves of the second tread pattern include portions oriented approximately at the first offset angle.

16. The method of claim 13, wherein the first plurality of universal bands include a first set of universal bands defined by a closed-shoulder of the first and the second tread patterns, and a second set of universal bands defined by a series of plateaus having a major dimension along the circumferential direction and a minor dimension along the lateral direction relative to the tire.

17. The method of claim 16, wherein the second plurality of universal bands include a first set of universal bands defined by a closed-shoulder of the first and the second tread patterns, and a second set of universal bands defined by a circumferential ridge.

18. The method of claim 13, wherein the plurality of reinforcing belts includes:
a first reinforcing belt having a first lateral edge beneath a first one of the universal bands and second lateral edge beneath a second one of the universal bands; and
a second reinforcing belt having a third lateral edge beneath a third one of the universal bands and fourth lateral edge beneath a fourth one of the universal bands.

19. The method of claim 18, wherein the plurality of reinforcing belts includes:
a third reinforcing belt having a fifth lateral edge beneath the first one of the universal bands and sixth lateral edge beneath the second one of the universal bands.

20. The method of claim 18, wherein the first, second, third, and fourth lateral edges are each situated beneath a middle 50% of the width of each corresponding one of the universal bands.
